(19) United States
(12) Patent Application Publication
(10) Pub. No.: US 2018/0174179 A1
(43) Pub. Date: Jun. 21, 2018

(54) SYSTEM AND METHOD FOR USING WALLET PAYMENT ON CONNECTED DEVICE TO SUPPORT PRICE OPTIMIZATION AND TARGETED CUSTOMER OFFER

(71) Applicant: MasterCard International Incorporated, Purchase, NY (US)

(72) Inventor: Manoneet Kohli, O'Fallon, MO (US)

(21) Appl. No.: 15/379,909

(22) Filed: Dec. 15, 2016

(51) Int. Cl. G06Q 30/02; G06Q 20/36

(52) U.S. Cl. CPC G06Q 30/0224; G06Q 20/36

(57) ABSTRACT

A method includes receiving payment account transaction data indicative of usage of a service facility. The method further includes identifying—from the received transaction data—users who used the service facility at a first time slot. In addition, the method includes transmitting an incentive offer to the identified users. The incentive offer may require use of the service facility at a second time slot. The service facility may be less highly utilized at the second time slot than at the first time slot.

### BACKGROUND

FIG. 1 is a block diagram that illustrates a conventional payment system 100.

The system 100 includes a conventional payment card/device 102. As is familiar to those who are skilled in the art, the payment card/device 102 may be a magnetic stripe card, an IC (integrated circuit) card, a fob, a payment-enabled smartphone, etc. The payment card/device 102 is shown being carried and used by an account holder/user 103.

The system 100 further includes a reader component 104 associated with a POS terminal 106. In some known manner (depending on the type of the payment card/device 102) the reader component 104 is capable of reading the payment account number and other information from the payment card/device 102.

The reader component 104 and the POS terminal 106 may be located at the premises of a retail store and operated by a sales associate of the retailer for the purpose of processing retail transactions. The payment card/device 102 is shown in FIG. 1 to be interacting with the reader component 104 and the POS terminal 106 for the purpose of executing such a transaction.

A computer 108 operated by an acquirer (acquiring financial institution) is also shown as part of the system 100 in FIG. 1. The acquirer computer 108 may operate in a conventional manner to receive an authorization request for the transaction from the POS terminal 106. The acquirer computer 108 may route the authorization request via a payment network 110 to the server computer 112 operated by the issuer of a payment account that is associated with the payment card/device 102. As is also well known, the authorization response generated by the payment card issuer server computer 112 may be routed back to the POS terminal 106 via the payment network 110 and the acquirer computer 108.

One well known example of a payment network is referred to as the “Banknet” system, and is operated by MasterCard International Incorporated, which is the assignee hereof.

The payment account issuer server computer 112 may be operated by or on behalf of a financial institution (“FI”) that issues payment accounts to individual users. For example, the payment account issuer server computer 112 may perform such functions as (a) receiving and responding to requests for authorization of payment account transactions to be charged to payment accounts issued by the FI; (b) tracking and storing transactions and maintaining account records; (c) rendering periodic account statements; and (d) receiving and tracking payments to the issuer from the account holders.

The components of the system 100 as depicted in FIG. 1 are only those that are needed for processing a single transaction. A typical payment system may process many purchase transactions (including simultaneous transactions) and may include a considerable number of payment account issuers and their computers, a considerable number of acquirers and their computers, and numerous merchants and their POS terminals and associated reader components. The system may also include a very large number of payment account holders, who carry payment cards or other devices for initiating payment transactions by presenting an associated payment account number to the reader component of a POS terminal.

For use-cases in which the payment card/device is embodied as a payment-enabled smartphone, the concept of a “digital wallet” has been introduced. In some implementations, the digital wallet takes the form of a payment-related application program (“app”) that is downloaded to and active on the smartphone. The user is permitted to load data (and/or an account-related payment app) corresponding to a number of different payment accounts (and possibly other types of credentials as well) into the wallet app. At the point of sale, the user opens the wallet app and selects one of the associated payment accounts for use in the present transaction. Via the wallet app or (as the case may be) the selected payment app, the corresponding payment credentials may be provided to the POS terminal to initiate the payment interaction among the merchant and other components of the payment account system.

The present inventor has recognized an opportunity to employ data generated by use of wallet apps to improve the balance of utilization over time of service facilities that have limited capacities.

### BRIEF DESCRIPTION OF THE DRAWINGS

Features and advantages of some embodiments of the present disclosure, and the manner in which the same are accomplished, will become more readily apparent upon consideration of the following detailed description of the disclosure taken in conjunction with the accompanying drawings, which illustrate preferred and exemplary embodiments and which are not necessarily drawn to scale, wherein:

FIG. 1 is a block diagram that illustrates a conventional payment system.

FIG. 2 is a block diagram that illustrates a utilization balancing system provided according to aspects of the present disclosure.

FIG. 3 is a simplified block diagram that illustrates a typical payment-enabled mobile device that may play a role in the utilization balancing system of FIG. 2.

FIG. 4 is a block diagram that illustrates a computer that may serve as a component of the utilization balancing system.

FIG. 5 is a flow chart that illustrates a process that may be performed in the utilization balancing system in accordance with aspects of the present disclosure.

FIG. 6 is an example screen display that may be presented to a user in connection with the process of FIG. 5.

FIG. 7 is a flow chart that illustrates a process that may be performed according to further aspects of the present disclosure.

### DETAILED DESCRIPTION

In general, and for the purpose of introducing concepts of embodiments of the present disclosure, transaction data is collected and analyzed concerning usage patterns over time of a service facility such as a pay-laundry facility, a carwash, etc. Times when usage typically peaks, thereby possibly causing delays for users, are noted. Users who tend to use the facility at peak times are identified, from their wallet app I.D. or payment-enabled device I.D. An incentive offer strategy is developed to spread or balance usage from peak times to less busy times. Offers such as discount offers are sent to peak-time users to give them an incentive to change their habits and use the service facility at less busy times. The same price discount is not offered to users who already employ the service facility at non-peak times.

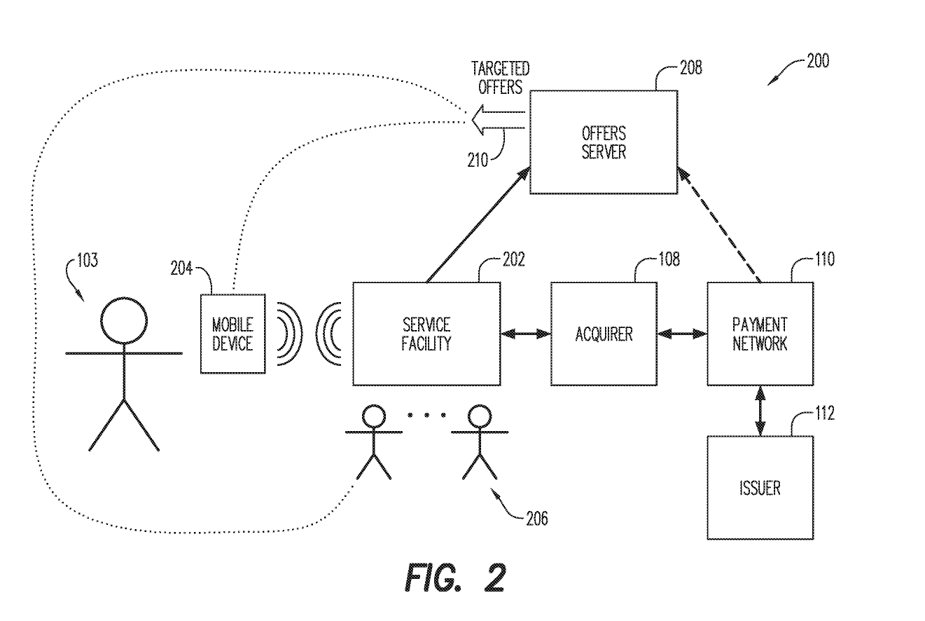

FIG. 2 is a block diagram that illustrates a utilization balancing system 200 provided according to aspects of the present disclosure.

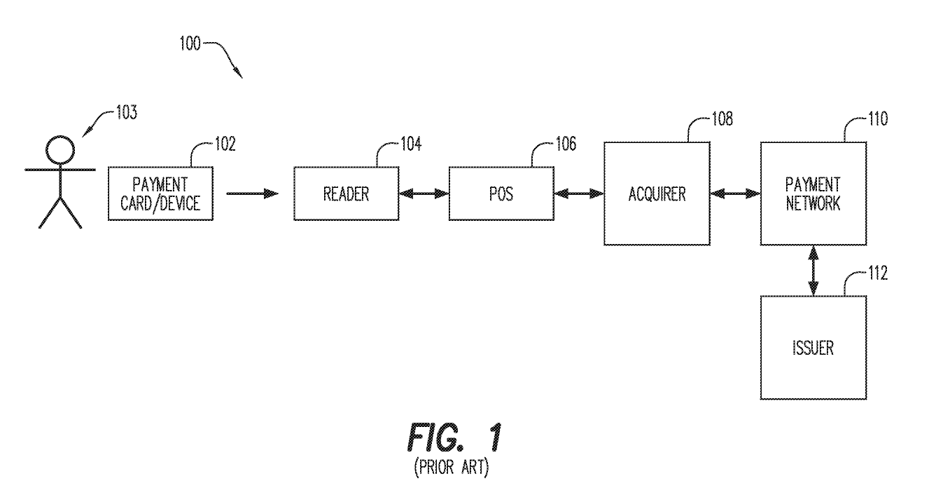

A function of the system 200 is to balance utilization of a service facility (represented by block 202). The service facility 202 may be, for example, an unattended pay-laundry facility, a carwash, a fitness facility such as a gym, a car-sharing service, a bicycle sharing service, etc. For present purposes it is assumed that payment for use of the facility occurs on a per-use basis and the payment account transactions are accepted for payment from, e.g., a payment-enabled mobile device. Thus the service facility 202 may incorporate some of the functionality of the POS terminal 106 and reader component 104 shown in FIG. 1, and the reader component 104 may be configured to accept payment via proximity radio communications from payment-enabled mobile devices. An example of such payment-enabled mobile devices is shown at 204 in FIG. 2 as being in short-range radio communication, for payment purposes, with the service facility 202. A user 103 is shown operating the payment-enabled mobile device 204 for purposes of engaging in a payment account transaction with the service facility 202. It is further assumed that FIG. 2 depicts a peak usage time with respect to the service facility 202 and that accordingly there is a crowd of other users 206 using or waiting to use the service facility 202. Although not explicitly shown in the drawing, it may be assumed that the users 206 are each carrying/using payment-enabled mobile devices.

Noting again that the service facility 202 functions for some purposes as a point of sale device, the service facility is shown connected to a transaction acquirer 108 to allow for routing of payment account transaction authorization requests via the acquirer 108 to an account issuer 112 via a payment network 110. The functioning of the elements 108, 110, 112 may be as described above in connection with FIG. 1.

An offers server computer 208 is also shown as part of the utilization balancing system 200. As discussed in more detail below, the offers server computer 208 may receive transaction data from the service facility 202. The transaction may indicate usage patterns for the service facility 202 and may be analyzed and processed by the offers server computer 208 such that the offers server computer 208 generates and transmits targeted incentive offers to users (as illustrated at 210) to encourage more balanced utilization of the service facility 202.

Although the service facility 202 is shown as the source of transaction data for the offers server computer 208, it may additionally or alternatively be the case that the offers server computer 208 is supplied with transaction data from one or more other components of the utilization balancing system 200, including for example payment network 110. In some embodiments, the offers server computer 208 may be under common operation with the payment network 110.

To discuss the subject matter of FIG. 2 more generally, it should be understood that in most cases, blocks labeled therein with names/descriptions of entities should also be understood to represent computer systems operated by or for such entities.

It should also be understood that the depiction of the utilization balancing system 200 in FIG. 2 may be considered to be simplified in that at least some types of components or entities represented by only a single block may in a practical embodiment be present in the system in rather large numbers. For example, the offers server computer 208 may operate to provide incentive offers to promote balancing of usage with respect to many different service facilities, the latter not being explicitly shown in the drawing apart from the service facility 202.

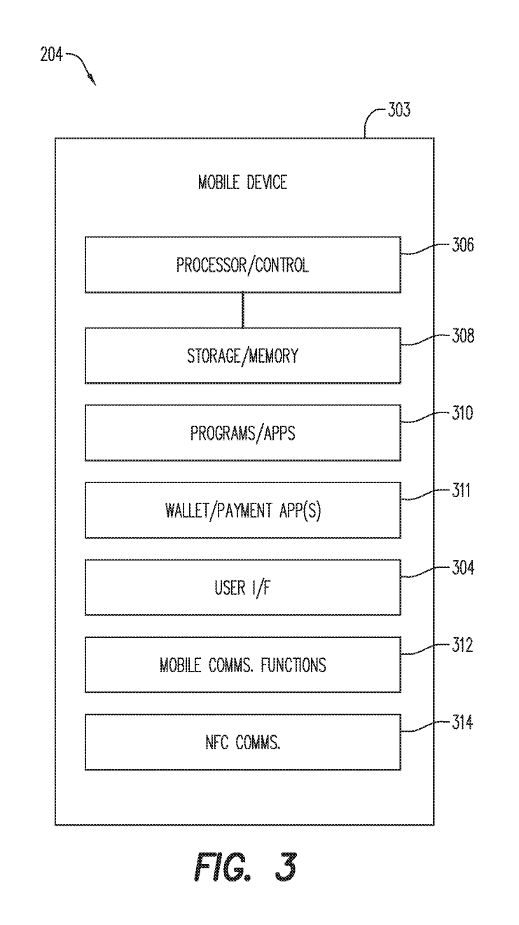

FIG. 3 is a block diagram of an example embodiment of the payment-enabled mobile device 204 shown in FIG. 2.

The mobile device 204 may include a housing 303. In many embodiments, the front of the housing 303 is predominantly constituted by a touchscreen (not separately shown), which is a key element of the user interface 304 of the mobile device 204.

The mobile device 204 further includes a mobile processor/control circuit 306, which is contained within the housing 303. Also included in the mobile device 204 is a storage/memory device or devices (reference numeral 308). The storage/memory devices 308 are in communication with the processor/control circuit 306 and may contain program instructions to control the processor/control circuit 306 to manage and perform various functions of the mobile device 204. As is well-known, a device such as mobile device 204 may function as what is in effect a pocket-sized personal computer (assuming for example that the mobile device is a smartphone), via programming with a number of application programs, or “apps”, as well as a mobile operating system (OS). (The apps are represented at block 310 in FIG. 3, and may, along with other programs, in practice be stored in block 308, to program the processor/control circuit 306.)

Also shown in FIG. 3 is a block 311 that represents a wallet app and/or one or more payment apps. The wallet/payment apps 311 are shown apart from the other apps represented at block 310, in part due to the particular relevance of the wallet/payment apps 311 to the subject of this disclosure. In addition, the separate representation of the wallet/payment apps 311 also may be considered to represent the possibility that they may be stored in a secured element (SE—not shown apart from block 311 or block 308), which may be provided in some embodiments of the payment-enabled mobile device 204 to provide enhanced security for the wallet/payment apps 311 and/or sensitive data associated therewith. The SE, if present, may be conventional in its hardware aspects. In addition or alternatively, security for the wallet/payment apps 311 may be enhanced by known alternatives to an SE, such as a TEE (trusted execution environment).

To the extent that the SE includes processing capabilities, it may functionally (though likely not physically) overlap with block 306; to the extent that the SE includes storage (and particularly program storage) capabilities, it may functionally (though likely not physically) overlap with block 308.

As is typical for mobile devices, the mobile device 204 may include mobile communications functions as represented by block 312. The mobile communications functions may include voice and data communications via a mobile communication network with which the mobile device 204 is registered.

In addition, to facilitate use as a payment-enabled device, the mobile device 204 may include short-range radio communications capabilities (block 314), including for example NFC (near field communication). Thus block 314 may represent a suitable antenna (not separately shown) that is appropriate for NFC communications as well as driving and receiving circuitry associated with the antenna. It will be appreciated that the NFC antenna may be separate and different from the antenna (not separately shown) utilized by the mobile device 204 for the mobile communication functions represented by block 312.

From the foregoing discussion, it will be appreciated that the blocks depicted in FIG. 3 as components of the mobile device 204 may in effect overlap with each other, and/or there may be functional connections among the blocks which are not explicitly shown in the drawing. It may also be assumed that, like a typical smartphone, the mobile device 204 may include a rechargeable battery (not shown) that is contained within the housing 303 and that provides electrical power to the active components of the mobile device 204.

It has been posited that the mobile device 204 may be embodied as a smartphone, but this assumption is not intended to be limiting, as mobile device 204 may alternatively, in at least some cases, be constituted by a tablet computer, smartwatch or by other types of portable electronic devices.

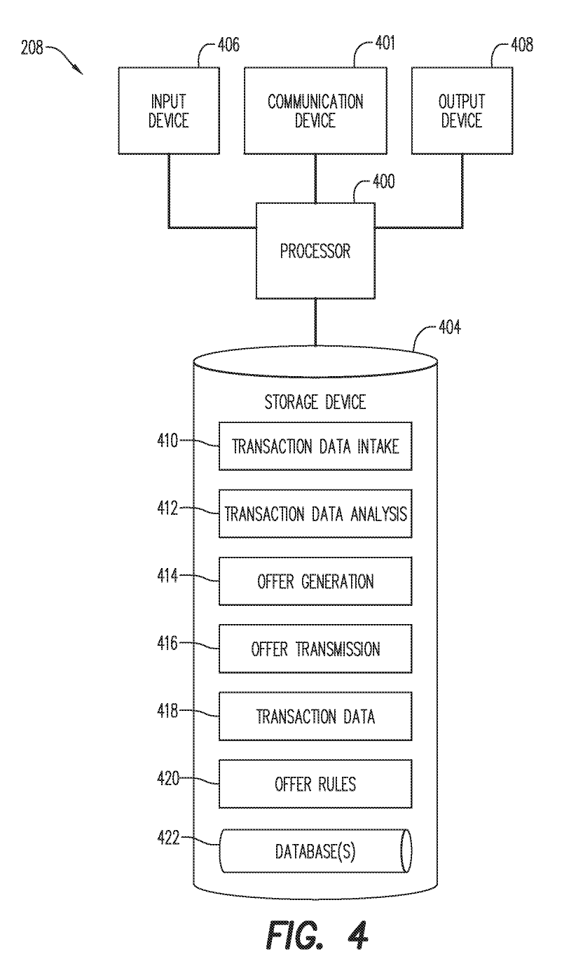

FIG. 4 is a block diagram representation of an embodiment of the offers server computer 208.

In some embodiments, hardware aspects of the offers server computer 208 may be constituted by typical server computer hardware and/or mainframe computer hardware, but may be controlled by software to cause the offers server computer 208 to function as described herein.

The offers server computer 208 may include a processor 400 operatively coupled to a communication device 401, a storage device 404, an input device 406 and an output device 408. The communication device 401, the storage device 404, the input device 406 and the output device 408 may all be in communication with the processor 400.

The processor 400 may be constituted by one or more processors. The processor 400 may operate to execute processor-executable steps, contained in program instructions described below, so as to control the offers server computer 208 to provide desired functionality.

Communication device 401 may be used to facilitate communication with, for example, other devices (such as the service facility 202; users' mobile devices). For example, communication device 401 may comprise numerous communication ports (not separately shown), to allow the offers server computer 208 to engage in many frequent and/or simultaneous communications with other devices.

Input device 406 may comprise one or more of any type of peripheral device typically used to input data into a computer. For example, the input device 406 may include a keyboard and a mouse. Output device 408 may comprise, for example, a display and/or a printer.

Storage device 404 may comprise any appropriate information storage device, including combinations of magnetic storage devices (e.g., hard disk drives), optical storage devices such as CDs and/or DVDs, and/or semiconductor memory devices such as Random Access Memory (RAM) devices and Read Only Memory (ROM) devices, as well as so-called flash memory. Any one or more of such information storage devices may be considered to be a computer-readable storage medium or a computer usable medium or a memory.

Storage device 404 stores one or more programs for controlling processor 400. The programs comprise program instructions (which may be referred to as computer readable program code means) that contain processor-executable process steps of the offers server computer 208, executed by the processor 400 to cause the offers server computer 208 to function as described herein.

The programs may include one or more conventional operating systems (not shown) that control the processor 400 so as to manage and coordinate activities and sharing of resources in the offers server computer 208, and to serve as a host for application programs (described below) that run on the offers server computer 208.

The programs stored in the storage device 404 may also include a transaction data intake program 410 that controls the processor 400 to cause the offers server computer 208 to operate so as to receive and store payment account transaction data relating to usage of the service facility 202.

Continuing to refer to FIG. 4, the storage device 404 may also store a transaction data analysis program 412. The transaction data analysis program 412 may control the processor 400 such that the offers server computer 208 analyzes the transaction data to detect patterns therein. More specifically, in some embodiments, the offers server computer 208 may, under control of the transaction data analysis program 412, detect patterns of peak usage or overload utilization of the service facility 202 as well as the identities of regular users who frequently use the service facility 202 at peak times.

Still further, the storage device 404 may store an application program 414 that controls the processor 400 to cause the offers server computer 208 to generate targeted incentive offers designed to shift usage of the service facility 202 from peak times to non-peak times. Further details of examples of incentive offers that may be generated by the application program 414 will be described below.

In addition, the storage device 404 may store an application program 416 that controls the processor 400 to cause the offers server computer 208 to transmit the incentive offers to selected (i.e., habitual peak-time) users of the service facility 202.

The storage device 404 may also store, and the offers server computer 208 may also execute, other programs, which are not shown. For example, such programs may include a reporting application, which may respond to requests from system administrators for reports on the activities performed by the offers server computer 208. The other programs may also include, e.g., device drivers, database management programs, communications software, etc.

The storage device 404 may also store a database 418 of the transaction data received (via operation of the program 410) relating to usage of the service facility 202. In addition, the storage device 404 may store a database 420 of offer rules to guide the offer generation application program 414 in determining what incentive offers to generate.

In some embodiments, the storage device 404 may also store one or more additional databases 422 as required for operation of the offers server computer 208.

Other computer components of the utilization balancing system 200 (FIG. 2) may also have the same type of hardware architecture and/or components as described above in connection with FIG. 4, and may be suitably programmed for the respective roles of those computer components.

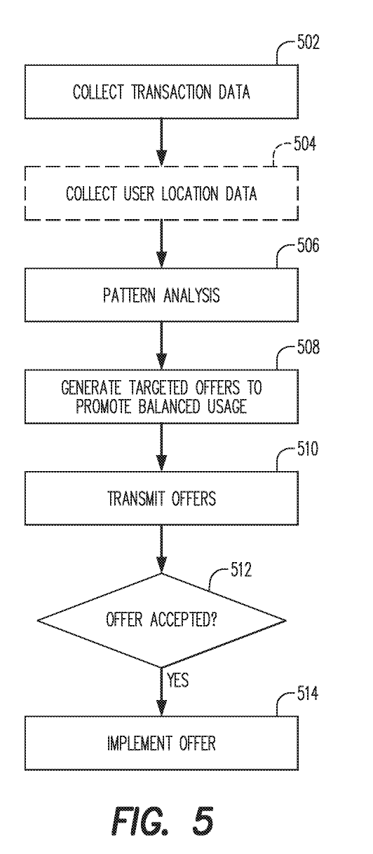

FIG. 5 is a flow chart that illustrates a process that may be performed in accordance with aspects of the present disclosure in the utilization balancing system 200.

At 502 in FIG. 5, payment account system transaction data related to usage of the service facility 202 may be stored in the offers server computer 208 (i.e., in the transaction database 418 (FIG. 4)). More specifically the transaction data may represent payment transactions entered into by users via their wallet apps to obtain access to the service facility 202. The transaction data may identify the users in the access transactions by, e.g., wallet app identifier and/or by mobile device identifier

At 506 in FIG. 5, the offers server computer 208 may perform a pattern analysis with respect to the transaction data (and also with respect to the user travel/location data, if available). A purpose of the analysis is to determine recurring time periods (also referred to as “time slots”) during each week (or other block of time) when the service facility 202 is typically highly- or over-utilized. As an additional input to the pattern analysis, the offers server computer 208 may have been provided with data that indicates the maximum or near-maximum capacity of the service facility 202. The latter data may be expressed, for example, in usage transactions per hour or per another unit of time. As to peak usage time slots (if resulting in overuse of the service facility 202), the pattern analysis may also identify users who typically utilize the service facility at the periods of excessive use.

At 508, the offers server computer 208 may generate a number of targeted incentive offers to be directed to peak-time users to attempt to shift their usage patterns away from peak times. The offers may be generated based on the pattern analysis of block 506 and also based on the offer rules stored in offer rules database 420 (FIG. 4). An example incentive offer may propose that the targeted user receive a discounted price for use of the service facility 202 within certain time slots that are not times of peak usage (e.g., for a laundry facility, early to mid afternoon on week days). As an alternative type of incentive offer, the targeted user may be given the opportunity for a service upgrade, again if he/she uses the service facility 202 within certain time slots that are not times of peak usage. Example service upgrades may include—for a laundry facility—an extra 10 minutes of clothes dryer time free of additional charge; or—for a carwash—a free wax treatment without any charge beyond the charge for a basic wash.

In some embodiments, the proposed time slot for effectiveness of the incentive offer may be individually tailored to the targeted user's apparent availability according to travel/location data (if available) for that individual user. For example, if the travel/location data indicates that the user is habitually away from the service facility during normal office work hours on Monday, Tuesday and Friday—and supposing that weekends and weekday evenings are peak usage times for the service facility 202—then the incentive offer for that user (who is assumed to be a habitual weekend user of the service facility 202) may specify one or more time slots during the morning or afternoon on Wednesdays and Thursdays to qualify for the offered incentive. It is to be noted that if a particular user is already in the habit of using the facility 202 at non-peak time slots, then it is advisable according to teachings of this disclosure that such user not be offered any incentive. Thus, the operator of the service facility 202 may reduce revenue loss due to discounting or other incentives by issuing targeted incentive offers only to habitual peak-time users, and refraining from a blanket peak-period pricing policy (or slack-period pricing policy).

At block 510 in FIG. 5, the offers server computer 208 may transmit the targeted offers generated at 508 to the users selected to receive the offers. This may be done via email and/or text message or by other addressing. In some embodiments, the preferred target devices to receive the transmitted incentive offers may be mobile devices such as the payment-enabled mobile device 204 shown in FIG. 2. In some embodiments, the offers server computer 208 may have access to a wallet app database (not shown) that contains, e.g., contact information such as mobile phone numbers and/or email addresses for the users who are associated with the particular instantiations of wallet apps downloaded to their mobile devices.

In some embodiments, the timing at which the incentive offer is transmitted may be dependent on the current location of the user (or more specifically—the current location of the user's mobile device). This may be determined according to the current geo-ip information about the mobile device, or via current location information obtained via another system, such as GPS, etc. The timing of transmission of the incentive offer, for example, may be at a time when the user/user device is located near the facility to be used.

The timing of transmission of the incentive offer may also reflect the timing of previous incentive offers sent for the same facility and/or the timing of the last occasion when the user used the facility. For example, if the user used the facility within the past 24 hours, the incentive offer may not be transmitted for a few days or a week after the user's last use of the facility. Similarly, no incentive offer may be transmitted for a given facility until a few days or a week after transmission of the previous incentive offer for the facility.

It is noted that determining whether and/or when to transmit an incentive offer to a user may be based on location data pertaining to/obtained from the user's mobile device. It may be the case that such location data is obtained only if the user has given permission to have his/her location tracked for this purpose. If the user prefers not to be tracked, it is expected that that preference will be respected.

It may also be the case that—for a given off-peak period—usage of the facility/presence of other users near or at the facility may be considered in determining whether to send out incentive offers for that off-peak period, such that an incentive offer is not sent if it may tend to overcrowd what is often an off-peak period.

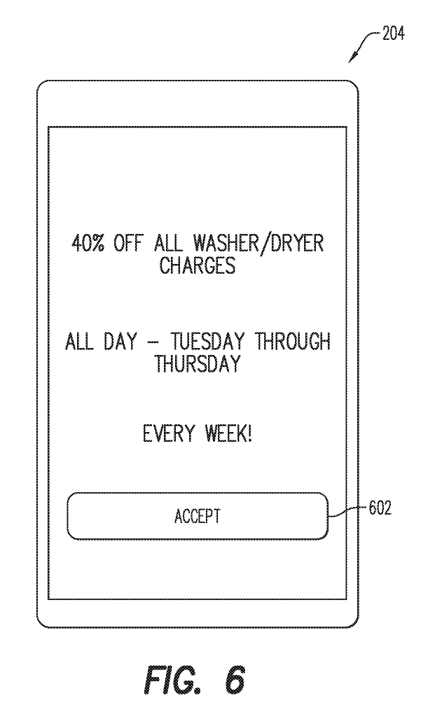

FIG. 6 shows an example of an incentive offer—as generated at 508 and transmitted at 510—and as displayed on the user interface of the mobile device 204, for example. It is assumed for purposes of the displayed offer that the service facility in the particular case is a laundry facility, and that the user is to be incentivized to change his/her pattern of usage from a peak time to non-peak time slots that exist all day on Tuesday, Wednesday and Thursday of each week. The incentive offered in this example is a price discount. An “accept” button 602 is included in the displayed offer and may be actuated by a touch of the user's finger (not shown).

In the process of FIG. 5, a decision block 512 is shown following block 510. At decision block 512, it is determined whether a user has accepted one of the transmitted incentive offers. If so, then block 514 follows decision block 512. At block 514, the offers server computer 208 may take one or more steps to implement the accepted incentive offer. For example, the offers server computer 208 may communicate to the service facility 202 that an incentive offer has been extended to and accepted by the user in question, identified for example by wallet app identifier and/or device identifier. The service facility 202 may then be configured to implement the incentive offer in question for the specific user.

To give one example of implementation is such a situation, (and assuming for example that the service facility is a laundry facility and the incentive is a price discount), the service facility may store the user identifying information as described above, and may automatically apply the incentive discount to access transactions by the user in the time slots designated in the offer.

In other examples (and in the case of price discount incentives), the offers server computer 208 may communicate with the acquirer, the payment network and/or the account issuer to intercept service facility access payment transactions that qualify for the discount and to adjust the pricing as called for by the accepted incentive offer.

In other examples, the acceptance of an incentive offer may prompt the offers server computer 208 to download a coupon in the form of a QR code or the like to the payment-enabled mobile device 204. The user may cause the payment-enabled mobile device to display the QR code/coupon upon claiming the discount or other incentive. The service facility 202, in conjunction with such an arrangement, may have a code-scanning component (not separately shown) and may be configured to read the coupon and to apply the incentive if the transaction is taking place in the required time slot.

As noted above, a possible advantage of the utilization balancing system 200 as described herein is that usage of a service facility may be balanced without resorting to a blanket “slack time” discount or other incentive that may sacrifice more revenue than the peak-time-user-targeted incentive offers as proposed according to teachings of the present disclosure.

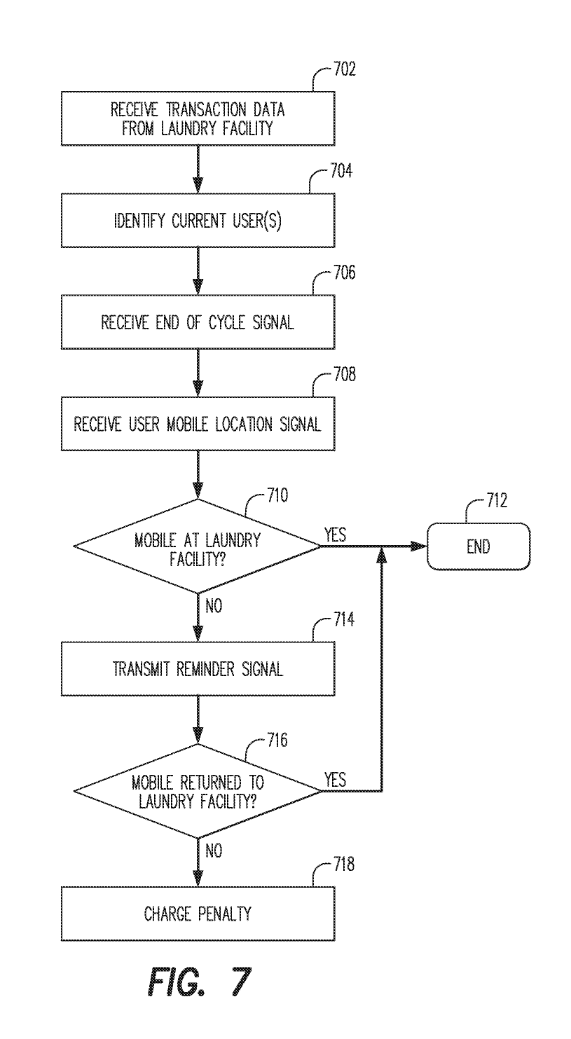

FIG. 7 is a flow chart that illustrates another process that may be performed in conjunction with the utilization balancing system 200. The process of FIG. 7 may represent an additional system feature that is directed more toward disciplined use of the service facility rather than balancing of usage. It is assumed for the purpose of FIG. 7 that the service facility 202 is a laundry facility. It is a potential goal of the process of FIG. 7 that users of the service facility 202 be present to unload clothing from the washer or dryer unit upon completion of the unit's operating cycle. It is also assumed for purposes of FIG. 7 that the offers server computer 208 (or another computer serving in a supervisory role) has access to frequent updates as to the current location of the payment-enabled mobile device 204 so as to be able to determine (in effect) whether the user 103 is present at the service facility 202 at a particular time.

At 702 in FIG. 7, the offers server computer 208 receives transaction data indicating a payment account access payment transaction for a particular washer or dryer unit (not separately shown) at the service facility 202. At 704, based on the transaction data, the offers server computer 208 may identify the user 103 (e.g., by wallet app identifier and/or mobile device identifier). At 706, the offers server computer 208 receives, from the service facility 202, a signal to indicate that the operating cycle of the washer or dryer unit has come or is coming to a conclusion. At 708, the offers server computer 208 receives or accesses a signal that indicates the current location of the payment-enabled mobile device 204.

A decision block 710 may follow block 708. At decision block 710, the offers server computer 208 may determine whether the payment-enabled mobile device 204 is present at the service facility 202. If so, then it may be inferred that the user 103 is also present at the service facility 202 and is available to remove his/her clothing from the washer or dryer unit in question. In such a case, the process of FIG. 7 may end, as indicated at 712.

If a negative determination is made at decision block 710 (i.e., if it is determined that the payment-enabled mobile device 204 is not present at the service facility 202), then block 714 may follow decision block 710. At block 714, the offers server computer 208 may send out a signal to the payment-enabled mobile device 204 to remind the user 103 to return to the service facility 202.

Decision block 716 may follow block 714. At decision block 716, the offers server computer 208 may track movement of the payment-enabled mobile device 204 to determine whether the payment-enabled mobile device 204 returns to the service facility 202. If so, then it may now be inferred that the user 103 is present at the service facility 202 and is available to remove his/her clothing from the washer or dryer. In this case, again the process may end per block 712.

If a negative determination is made at decision block 716 (i.e., if the payment-enabled mobile device is not returned to the service facility 202), then block 718 may follow decision block 716. At block 718, the offers server computer 208 may assess a penalty against the user 103. For example, the penalty may be implemented via an additional charge to the payment account that the user 103 used for the access payment transaction to access the washer or dryer.

As used herein and in the appended claims, the term “computer” should be understood to encompass a single computer or two or more computers in communication with each other.

As used herein and in the appended claims, the term “processor” should be understood to encompass a single processor or two or more processors in communication with each other.

As used herein and in the appended claims, the term “memory” should be understood to encompass a single memory or storage device or two or more memories or storage devices.

As used herein and in the appended claims, a “server” includes a computer device or system that responds to numerous requests for service from other devices.

The flow charts and descriptions thereof herein should not be understood to prescribe a fixed order of performing the method steps described therein. Rather the method steps may be performed in any order that is practicable, including simultaneous performance of steps.

As used herein and in the appended claims, the term “payment card system account” includes a credit card account, a deposit account that the account holder may access using a debit card, a prepaid card account, or any other type of account from which payment transactions may be consummated. The terms “payment card system account” and “payment card account” and “payment account” are used interchangeably herein. The term “payment card account number” includes a number that identifies a payment card system account or a number carried by a payment card, or a number that is used to route a transaction in a payment system that handles debit card and/or credit card transactions. The term “payment card” includes a credit card, debit card, prepaid card, or other type of payment instrument, whether an actual physical card or virtual.

As used herein and in the appended claims, the term “payment card system” refers to a system for handling purchase transactions and related transactions. An example of such a system is the one operated by MasterCard International Incorporated, the assignee of the present disclosure. In some embodiments, the term “payment card system” may be limited to systems in which member financial institutions issue payment card accounts to individuals, businesses and/or other organizations.

Although the present disclosure has been described in connection with specific exemplary embodiments, it should be understood that various changes, substitutions, and alterations apparent to those skilled in the art can be made to the disclosed embodiments without departing from the spirit and scope of the disclosure as set forth in the appended claims.

What is claimed is:

1. A method comprising:
receiving payment account transaction data indicative of usage of a service facility;
identifying, from the received transaction data, users who used the service facility at a first time slot; and
transmitting an incentive offer to said identified users, said incentive offer requiring use of the service facility at a second time slot, the service facility less highly utilized at said second time slot than at said first time slot.

2. The method of claim 1, wherein said users are identified based on the user's digital wallet identifier.

3. The method of claim 1, wherein said users are identified based on the user's payment-enabled mobile device identifier.

4. The method of claim 1, wherein the incentive offer includes an offer of a discounted price for using the service facility.

5. The method of claim 1, wherein the incentive offer includes an offer of a service upgrade.

6. The method of claim 1, wherein the incentive offer is transmitted to the identified users' mobile devices.

7. The method of claim 1, wherein the incentive offer is transmitted to said identified users during said first time slot.

8. The method of claim 1, wherein the service facility includes at least one of: (a) a laundry facility; (b) a fitness facility; (c) a car sharing service; (d) a bicycle sharing service; and (e) a carwash.

9. A method comprising:
receiving transaction data that indicates a user has engaged in a payment account transaction for utilizing a laundry facility at a first time;
receiving a first signal, the first signal received at a later time than the first time, the first signal indicating that an operating cycle of the laundry facility is concluding;
receiving a second signal that indicates that the user's mobile device is not present at the laundry facility at said later time; and
in response to the received first and second signals, transmitting a reminder signal to said mobile device to alert the user to ending of the operating cycle of the laundry facility.

10. The method of claim 9, wherein the reminder signal indicates that the user is to be charged a financial penalty if the user does not return to the laundry facility within a predetermined time after transmission of the reminder signal.

11. The method of claim 10, further comprising:
charging the financial penalty to a payment account belonging to the user.

12. The method of claim 11, wherein the payment account to which the financial penalty is charged was used for the payment transaction for utilizing the laundry facility.

13. An apparatus comprising:
a processor; and
a memory in communication with the processor, the memory storing program instructions, the processor operative with the program instructions to perform functions as follows:
receiving payment account transaction data indicative of usage of a service facility;
identifying, from the received transaction data, users who used the service facility at a first time slot; and
transmitting an incentive offer to said identified users, said incentive offer requiring use of the service facility at a second time slot, the service facility less highly utilized at said second time slot than at said first time slot.

14. The apparatus of claim 13, wherein said users are identified based on the user's digital wallet identifier.

15. The apparatus of claim 13, wherein said users are identified based on the user's payment-enabled mobile device identifier.

16. The apparatus of claim 13, wherein the incentive offer includes an offer of a discounted price for using the service facility.

17. The apparatus of claim 13, wherein the incentive offer includes an offer of a service upgrade.

18. The apparatus of claim 13, wherein the incentive offer is transmitted to the identified users' mobile devices.

19. The apparatus of claim 13, wherein the incentive offer is transmitted to said identified users during said first time slot.

20. The apparatus of claim 13, wherein the service facility includes at least one of: (a) a laundry facility; (b) a fitness facility; (c) a car sharing service; (d) a bicycle sharing service; and (e) a carwash.
